(19) United States
(12) Patent Application Publication
(10) Pub. No.: US 2012/0180126 A1
(43) Pub. Date: Jul. 12, 2012

(54) Probable Computing Attack Detector

(76) Inventors: Lei Liu, Fairfax, VA (US); Guanhua Yan, (US); Xinwen Zhang, San Jose, CA (US); Songqing Chen, Fairfax, VA (US)

(21) Appl. No.: 13/181,629

(22) Filed: Jul. 13, 2011

Related U.S. Application Data
(60) Provisional application No. 61/363,790, filed on Jul. 13, 2010.

(51) Int. Cl. G06F 21/00; G06F 11/00

(52) U.S. Cl. 726/22

(57) ABSTRACT

A probable computing attack detector monitors electrical power consumption of a computing device. Task data may be acquired for at least one task operating on the computing device. A predicted electrical power consumption may be calculated for the computing device employing a user-centric power model and the task data. A probable attack may be detected when the electrical power consumption disagrees with the predicted electrical power consumption by a determined margin.

### CROSS-REFERENCE TO RELATED APPLICATIONS

This application claims the benefit of U.S. Provisional Application No. 61/363,790, filed Jul. 13, 2011, entitled “Mobile Device Malware Detector,” which is hereby incorporated by reference in its entirety.

### STATEMENT REGARDING FEDERALLY SPONSORED RESEARCH OR DEVELOPMENT

This invention was made with government support under Grant Number CNS-0746649 awarded by the National Science Foundation and Grant Number FA9550-01-1-0071 awarded by the Air Force Office of Scientific Research. The government has certain rights in the invention.

### BACKGROUND

Due to the rapid advancement of communication technology, computing devices such as mobile devices may support a variety of data services that have not traditionally been available. With the growing popularity of mobile devices in the last few years, attacks targeting them are also surging. Existing attack detection techniques, for example existing mobile malware detection techniques are often borrowed from solutions to Internet malware detection and/or do not perform effectively due to the limited computing resources on mobile devices.

With—improving chip design technology, computing power of microprocessors are continuously increasing, which enables a relatively greater number of features on mobile devices not available in the past. For example, cellphones may include various emerging data services, such as text messaging, emailing, Web surfing, in addition to traditional voice services. Due to their all-in-one convenience, these increasingly powerful mobile devices are gaining a lot of popularity. Moreover, the new generation of mobile devices provide a more open environment than their ancestors. Newer mobile devices may not only run sandbox applications shipped from original manufacturers, but also install and execute third-party applications that conform to the norms of their underlying operating systems.

The new features brought by exotic applications, although rendering mobile devices more attractive to their users, also may open the door for malicious attacks. By the end of 2007, there were over 370 different mobile malware in the world. The debut of Cabir in 2004, which spreads through Bluetooth connections, is commonly accepted as the inception of modern cellphone virus. Since then, a number of malware instances have been found to exploit vulnerabilities of mobile devices, for example Cabir and/or Commwarrior. These mobile malware have created serious security concerns to not only mobile users, but also to network operators. Security concerns may include information stealing, overcharging, battery exhaustion, and/or network congestion.

Despite the immense security threats posed by mobile malware, their detection and defense is still lagging behind. Many signature- and anomaly-based schemes for IP networks have been extended for mobile network malware detection and prevention. However, what may be needed is an attack detection mechanism for computing devices, for example a malware detection mechanism for mobile devices.

### BRIEF DESCRIPTION OF THE SEVERAL VIEWS OF THE DRAWINGS

FIG. 1 is an example block diagram of a malware detector as per an aspect of an embodiment of the present invention.

FIG. 2 is an example block diagram of a malware detector as per an aspect of an embodiment of the present invention.

FIG. 3 is an example flow diagram of a state machine constructor as per an aspect of an embodiment of the present invention.

FIG. 4 is an example flow diagram of a state machine constructor as per an aspect of an embodiment of the present invention.

FIG. 5 is an example block diagram of a malware detector as per an aspect of an embodiment of the present invention.

FIG. 6 is an illustration of n example mobile device interface as per an aspect of an embodiment of the present invention.

FIG. 7 is an example diagram of an example malware operation flow detectable by an aspect of an embodiment of the present invention.

FIG. 8A through FIG. 8C are tables showing experimental results conducted with an embodiment of the present invention.

FIG. 9A through FIG. 9C are tables showing experimental results conducted with an embodiment of the present invention.

FIG. 10 is a plot of overhead experimental results conducted with an embodiment of the present invention.

FIG. 11 is a flow diagram of a probable computing attack detector according to an aspect of an embodiment of the present invention.

FIG. 12 is a flow diagram of electrical power consumption monitoring according to an aspect of an embodiment of the present invention.

FIG. 13 is a flow diagram of task acquisition according to an aspect of an embodiment of the present invention.

FIG. 14 is a flow diagram of a predicted power consumption calculation according to an aspect of an embodiment of the present invention.

FIG. 15 is a block diagram of a probable attack detector according to an aspect of an embodiment of the present invention.

### DETAILED DESCRIPTION OF EMBODIMENTS

Embodiments of the present invention employ power measurements to detect anomalous behaviors on mobile devices. Mobile devices are usually battery powered and any malicious activity may inevitably consume some battery power. By monitoring power consumption on a mobile device, some embodiments of the present invention detect misbehaviors that lead to abnormal power consumption. Some embodiments of the present invention rely on a user-centric power model that characterizes power consumption of common user behaviors. Some embodiments of the present invention may use a real-time mode to perform fast malware detection with low runtime overhead. Some embodiments of the present invention may apply relatively sophisticated machine learning techniques to further improve the detection accuracy during a battery charging mode.

Some embodiments of the present invention detect malware on mobile devices without demanding significant external support. The design of some embodiments of the present invention are based on the fact that mobile devices are commonly battery powered and any malware activity on a mobile device will inevitably consume battery power. Some embodiments of the present invention monitor and audit power consumption on mobile devices with a behavior-power model that characterizes power consumption of normal user behaviors. Towards this goal, some embodiments of the present invention overcome several challenges. First, some embodiments of the present invention may employ a power model that characterizes power consumption of user behaviors on mobile devices. Second, some embodiments of the present invention may measure battery power in real time. However, precise battery power measurement may be difficult due to many electro-chemical properties. In addition, although in practice mobile devices commonly have battery power indicators, their precision may vary significantly from device to device. Examining the battery capacity frequently may also incur relatively high computational overhead. Third, running detection on on-the-shelf mobile devices without external support may need to be lightweight without consuming too much CPU (and thus battery power) to not adversely affect the detection accuracy.

To overcome these challenges, some embodiments of the present invention may use a user-centric power model that, as opposed to a system-centric model which may require an in-depth understanding of various system-level behaviors and states, has only a small number of states based on common user operations. Some embodiments of the present invention may run in at least two modes including a real-time mode and a battery-charging mode. A real-time detection mode may perform fast malware detection. A battery-charging mode 244 may apply advanced machine learning techniques to detect stealthy malware with a higher accuracy than the fast malware detection.

An example embodiment of the present invention was built on a Nokia 5500 Sport and evaluated with real cellphone malware, including FlexiSPY and Cabir. Experimental results on example embodiments show that malware activities were detected with less than approximately 1.5% additional power consumption in real time. In a battery-charging mode 244, some embodiments of the present invention, by using advanced machine learning techniques, may considerably improve the detection rate up to approximately 98.6%.

Some embodiments of the present invention employ the fact that malware activities on a mobile device consume battery power. Hence, abnormal battery power consumption may be a good indicator that some misbehavior has been and/or is being conducted. Accordingly, some embodiments of the present invention monitor battery power usage on a mobile device and compares the battery power usage against a pre-defined power consumption model to identify abnormal activities ascribed to mobile malware.

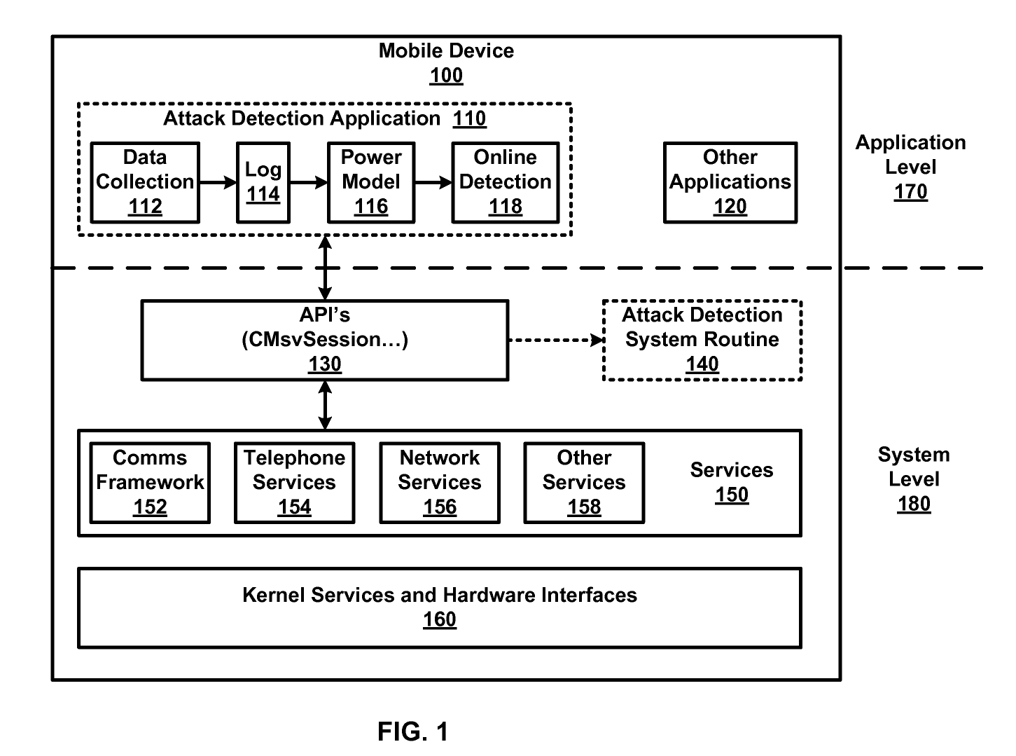

Example FIG. 1 illustrates a workflow of some embodiments of the present invention when executed on a mobile device 100. Some embodiments of the present invention may run at either a system level 180 and/or an application level 170 along with other applications 120. Running an attack detector 140 at a system level 180 may be more robust against attacks since mobile OSes, such as Symbian and Windows Mobile, are often only accessible to device manufacturers and/or authorized parties using, for example, kernel services and hardware interface 160. As illustrated in FIG. 1, APIs 130 provided by the underlying mobile OS may collect information of supported services 150 (e.g. Comms Framework 152, telephone services 154, network services 156 and other services 158) as well as the current remaining battery capacity from application 110. Application 110 may include a data collector 112, a log 114, a power module 116 and an online detection. The data collector 112 may collect battery data or other data such as environmental data. Log 114 may record the data collected from data collection element 112. Power model 116 may be employed to calculate predicted/estimated power consumption. Online detection 118 may determine when a probable attack has occurred employed the predicted power consumption and the actual power consumption. Some embodiments of the present invention, based on a power model, may calculate how much power could have been consumed due to services 150 and compares calculated power usage against measured power consumption. The comparison result may indicate whether abnormal power draining has occurred. If the difference exceeds a threshold, some embodiments of the present invention may raise an alarm indicating the existence of potential malware. Such comparison may be done in real-time (e.g., a real-time mode 242) for fast malware detection, or when the battery is charging (e.g., a battery-charging mode 244) for high detection accuracy.

Alarms raised by some embodiments of the present invention may reveal malicious activities of the mobile malware. For instance, a user may check the communication records of their mobile device provided by a network operator to determine whether there are any suspicious phone calls and/or text messages and/or may run more advanced virus removal tools to clean the mobile device. Hence, some embodiments of the present invention may expose malware on mobile devices to their users at relatively early stages, thus preventing them from continuously compromising the service security and/or data confidentiality of the mobile device.

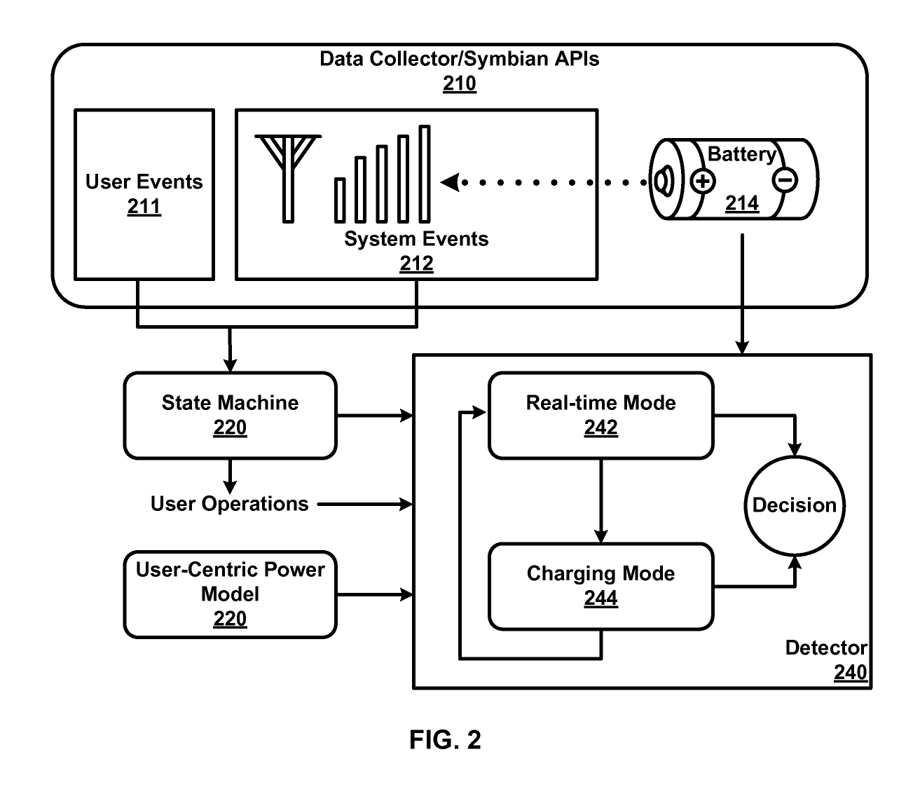

The power model in some embodiments of the present invention may be user-centric, which is relative to system-centric models that typically have many system-level states. According to some embodiments of the present invention, a power model may be constructed when the device is in a clean state. Some embodiments of the present invention may include one or more of the following components: a User-Centric Power Model, Data Collector and/or a Malware Detector 240. Example FIG. 2 illustrates these example components and a work flow of some embodiments of the present invention.

Building a User-Centric Power Model 220 for some embodiments of the present invention: Existing Battery Power Models

Generally, a battery's 214 power consumption rate may be affected by one or more groups of factors, for example environmental factors and/or user operations . Environmental factors may include signal strength, environmental noises, temperature, humidity, the distance to the base station, the discharging rate, the remaining battery power, etc. User operations may include phone calls, emailing, text messaging, music playing, etc. Power models which may be used include linear models, discharge models, relaxation models, combinations of the above, or the like.

Linear models: In this relatively simple model, the remaining capacity after operating duration t_{d} may be given by:

Pᵣ=Pₚ−∫ₜ₌ₜ_{₀}^{t}^{₀}^{+t}^{_{d}}d(t)dt=Pₚ−I×t_{d} (1)

where Pₚ is the previous battery power, and d(t) is the draining rate at time t. With the assumption that the operating mode does not change for t_{d} time units, d(t) may stay the same during this period and is denoted as I. Once the operation mode changes, the remaining capacity may be re-calculated.

Discharge Rate Dependent Model: In this model, the discharge rate may be considered to be related to the battery capacity. For this purpose, c may be defined as the fraction of the effective battery capacity P_{eff} and the maximum capacity Pₘₐₓ, i.e., c=P_{eff}Pₘₐₓ. Then the battery power may be calculated as:

Pᵣ=c×Pₚ−∫ₜ₌ₜ_{⁰}^{t}^{₀}^{+t}^{_{d}}d(t)dt=c×Pₚ−I×t_{d} (2)

c changes with the current; it may become close to 1 when the discharge rate is low, and may approach 0 when the discharge rate is high.

Relaxation Model: This model is based on a common phenomenon called relaxation, which refers to the fact that when a battery 214 is discharged at a high rate, the diffusion rate of the active ingredients through the electrolyte and electrode may fall behind, and the 214 reaches its end of life even if there are active materials available. If the discharge current is cut off or reduced, the diffusion and transport rate of active materials may catch up with the depletion of the materials. Although this is a relatively comprehensive model characterizing a real battery 214, the model involves more than 50 electro-chemical and physical input parameters.

All these models may calculate the battery power consumption from a physical and electrical perspective, although their inputs may be different. The relaxation model may provide more accurate battery estimation than the linear model. However, even with aid of external instruments, measuring over 50 parameters could be difficult and expensive in practice. In addition, some embodiments of the present invention may aim to run on mobile devices which rely on publicly available functions (e.g., without external support) to collect data, for example from system events 212. Most of the 50 parameters in the relaxation model, however, may not be captured with available APIs. Furthermore, a model with as many as 50 parameters may be too cumbersome, and thus not suitable for resource-constrained devices. The other two models may have similar problems, as the power draining rate and discharge rate are hard to measure without external power measurement instruments.

User-Centric Power Model

Due to the difficulties of measuring the input parameters of existing power models, some embodiments of the present invention may use a user-centric power model. In this kind of a model, the amount of power consumed may be characterized as a function of user operations and/or environmental factors, for example common user operations and/or relevant environmental factors. Moreover, this kind of a model may be implemented with only a few states, in contrast to those system-centric power models that may need a cumbersome profile of numerous system behaviors and may be difficult to build without in-depth understanding of the mobile OS and its underlying hardware.

According to some embodiments of the present invention, a user-centric model may need to model the power consumption of common types of user operations on mobile devices in different environments. One or more of the following types of user operations may be considered: (1) Calling: Power consumption may be dependent on the conversation duration. Some embodiments of the present invention may treat incoming and outgoing calls separately. (2) Messaging: Average power consumption may depend on both the sizes and the types of the messages. MMS and SMS are two message types that may be considered. Also, sending and receiving messages may be treated as different activities. (3) Emailing: Power consumption may be decided by the amount of traffic, which may be related to the email message size. (4) Document processing: The duration of the operation may be a factor. (5) Web surfing: Web surfing is more complicated than the above as a user may view, download, or be idle when surfing the Web. Average power consumption may be based on the amount of traffic involved and surfing duration. (6) Idle: For a large amount of time, a user may not operate on the device for anything. During this period, however, system activities such as signaling may still take place. Under such a state, the power consumption may be intuitively relevant to its duration. (7) Entertainment and others: In a simple mode, the average power consumption may be determined by the duration of the activities. It is envisioned that more complicated models may be configured to adapt to specific activities.

For environmental factors, one or more of the following types may be considered: (1) Signal strength: Signal strength may impact the power consumption of all the above operations. The weaker of the signal strength, the more power consumption is expected. (2) Network condition: For some of the operations, network conditions may also be important. For example, the time, and thus the power, needed to send a text message may depend on the current network condition.

In some embodiments of the present invention, the battery power consumed between two measurements may be described as a function of all these factors during this period:

ΔP=f(D_{call}ⁱ, SS_{call}ⁱ, T_{msg}^{j}, S_{msg}^{j}, SS_{msg}^{j}, N_{msg}^{j}, . . . , D_{idle}^{k}, SS_{idle}^{k}) (3)

where ΔP represents the power consumption, D the duration of the operation, SS the signal strength, T the type of the text message, and N the network condition. i, j, and k represent the index of the user operation under discussion.

The function in the user-centric power model may be derived from the following three different approaches:

Linear Regression: Linear regression may generate a mathematical function which linearly combines variables discussed with techniques such as least square functions; it may thus be stored and implemented in a relatively small segment of code that runs on commodity mobile devices with relatively low overhead. While linear regression may incur little overhead, which makes it suitable for real-time detection, its accuracy may depend on the underlying assumption of the linear relationship between variables.

Neural Network: An artificial neural network (ANN), often referred to as a “neural network” (NN), is a mathematical and/or computational model inspired by biological neural networks. It may consist of an interconnected group of artificial neurons that process information using a connectionist approach for computation. Neural networks may be used for non-linear statistical data modeling. They may be used to model complex relationships between inputs and outputs and/or to find patterns in data. In some embodiments of the present invention, neural network(s) may be employed as a regression tool, in which the neural network model, unlike the linear regression model, may not easily be presented as a mathematical function.

Decision Trees: A decision tree is a predictive model that maps the observations of an item to conclusions of its target value. In a decision tree, branches may represent conjunctions of features that lead to leaves that represent classifications. In some embodiments of the present invention, a classification tree may be employed in which branches represent normal and/or malware samples. The decision tree may be trained with both normal and malware data samples. When a new piece of data sample is fed into the decision tree, it may determine whether the new data is normal or not, as well as which malware most likely caused the abnormal power consumption.

Constructing State Machines 220 for Data Collection

According to some embodiments of the invention, training the power models presented in the previous section may need to collect some data. For the linear and neural network model construction, only clean data may be needed (e.g., data in the absence of malware programs. For decision tree construction, both clean data and dirty data (e.g., data when malware programs are present) may be needed. The processes which some embodiments of the present invention may collect these data, to train the models, will now be discussed.

According to some embodiments, although the power consumption may be queried using public APIs, there may not be an interface that may be directly called for user operations. Since commodity devices may provide some APIs for third parties to query, register, and/or monitor system-level events 212 and/or status, a state machine 220 may be constructed to derive user operations (e.g. external events 211) from system events 212 (e.g., internal events). In this state machine 220, state transitions may be triggered by internal events when they appear in a certain order and/or satisfy certain timing constraints. For example, on some cell phones, during a normal incoming call, a ring event must precede another answer key event, but cannot happen more than 25 seconds before the answer key event since ringing lasts for less than 25 seconds in a cellphone before the call is forwarded to the voicemail service.

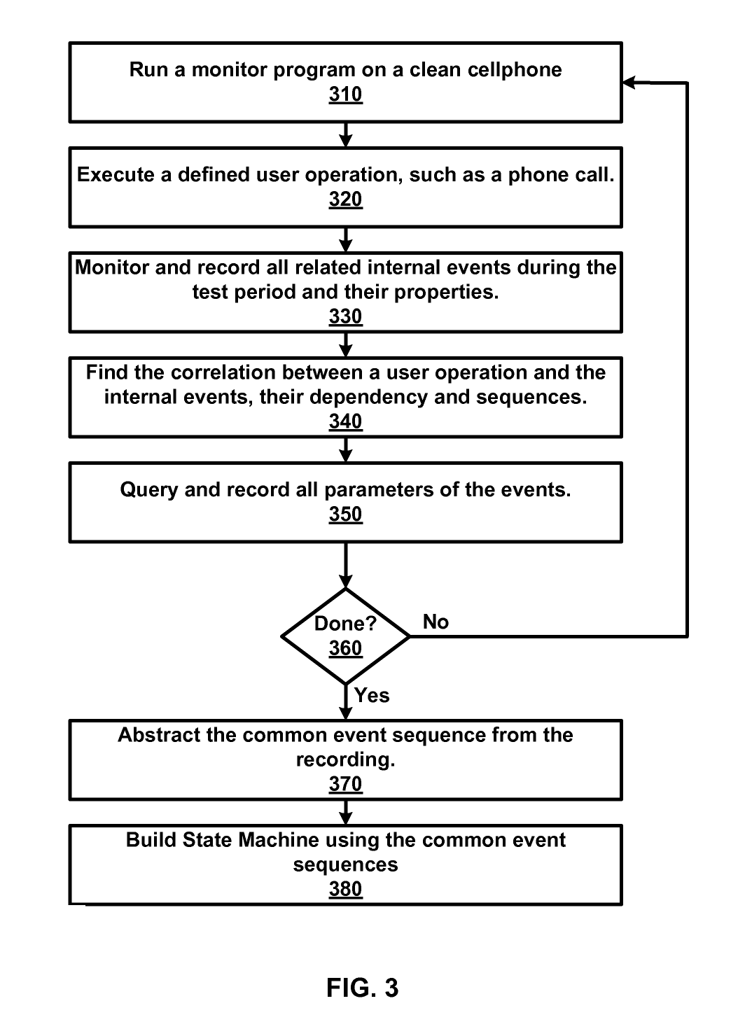

Some embodiments of the present invention may perform the actions illustrated in example FIG. 3 to construct a state machine(s) for user operation(s) defined previously. At 310, a monitor program may be run on a clean cellphone. A defined user operation(s), such as a phone call may be executed at 320. Related internal events and their properties may be monitored and/or recorded during a test period at 330. Correlation between a user operation and the internal events, their dependencies and sequences may be determined at 340. Parameters for events may be queried and recorded at 350. At 360, a determination may be made if the experiment should be repeated to collect more data. Common event sequence(s) may be abstracted from the recording at 370. A State Machine may be built at 380 using the common event sequences.

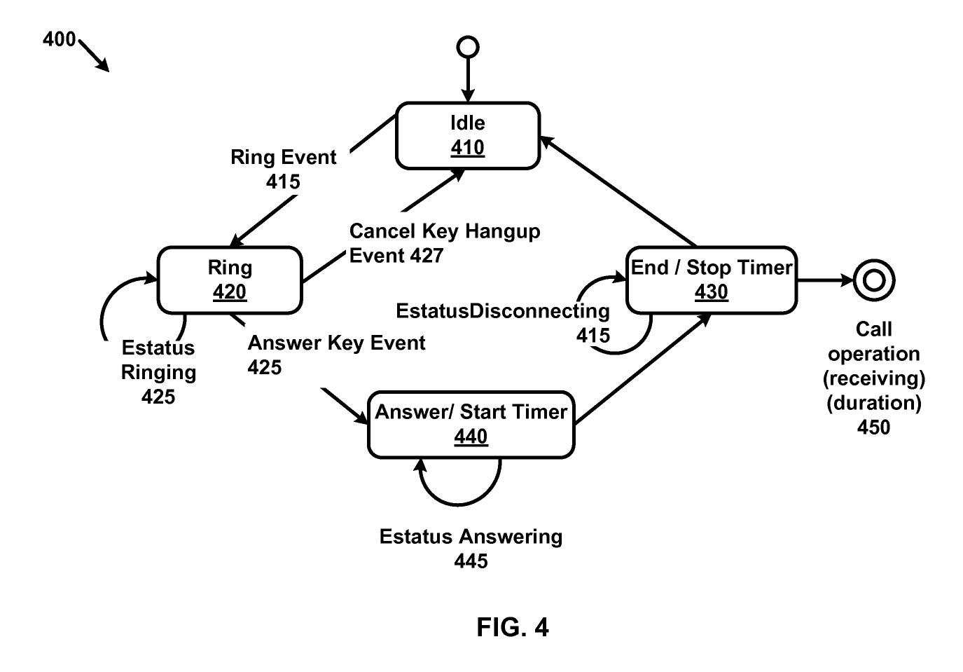

Example FIG. 4 illustrates an example of constructed state machine 400 configured to receive a phone call as per an aspect of an embodiment of the present invention. In FIG. 4, the triggering events may be marked on the transition arrows.

Starting in an Idle state 410, state machine 400 transits to the Ring state 420 after a ring event 415. On a Symbian cell phone, an Ringing 425 may be observed. If the user decides to answer the call by pressing the answer key, the answer key event 425 may be generated, which makes state machine 400 move to Answer state 440 if the answer key event 425 happens between half a second and 25 seconds after Ring state 420. On a Symbian cell phone, an EStatusAnswering event 445 may be observed. At this time, state machine 400 starts a timer. When the user terminates the call by pressing the cancel key or hanging it up (Cancel Key Hangup Event 427), state machine 400 turns to End state 430 followed by a Symbian EStatusDisconnecting event 415. State machine 400 stops the timer and calculates the calling duration. Finally, state machine 400 returns to Idle state 410 and generates a receiving call operation 450 with the call duration. In a similar approach, state machines may be built for other user operations.

Model Checking for Malware Detection

With the power model and the state machines available, some embodiments of the present invention may perform malware detection as follows. The power model may be employed to predict how much power should be consumed and then compare the prediction of power consumption against the measured power consumption. If abnormal power consumption is observed, an alert may be raised. Some embodiments of the present invention may be designed with one or more of the following running modes: a real-time mode 242 band/or a battery charging mode 244.

A real-time mode 242 according to some embodiments of the present invention may employ a model that makes quick real-time detections such as, for example, the linear regression power model to predict power consumption due to its low computational cost.

Although linear regression may be relatively easy to perform, it may generate false detection results since (1) linear regression may implicitly assume a linear relationship among all variables and/or (2) power measurements may have fluctuations due to electro-chemical battery properties. Thus, some embodiments of the present invention may utilize a battery charging modes where accumulated power consumption measurement data is analyzed employing a more complex model such as, for example, a neural network model and/or a decision tree algorithm to perform malware detection when the battery is charging.

It is noted that one or more modes may run off of a mobile device. For example, a device manufacturer and/or a service operator may provide a service allowing a user and/or a device to submit collected measurement data to a server for malware detection. This may increase the communication cost on a mobile device but save on a mobile device processing cost.

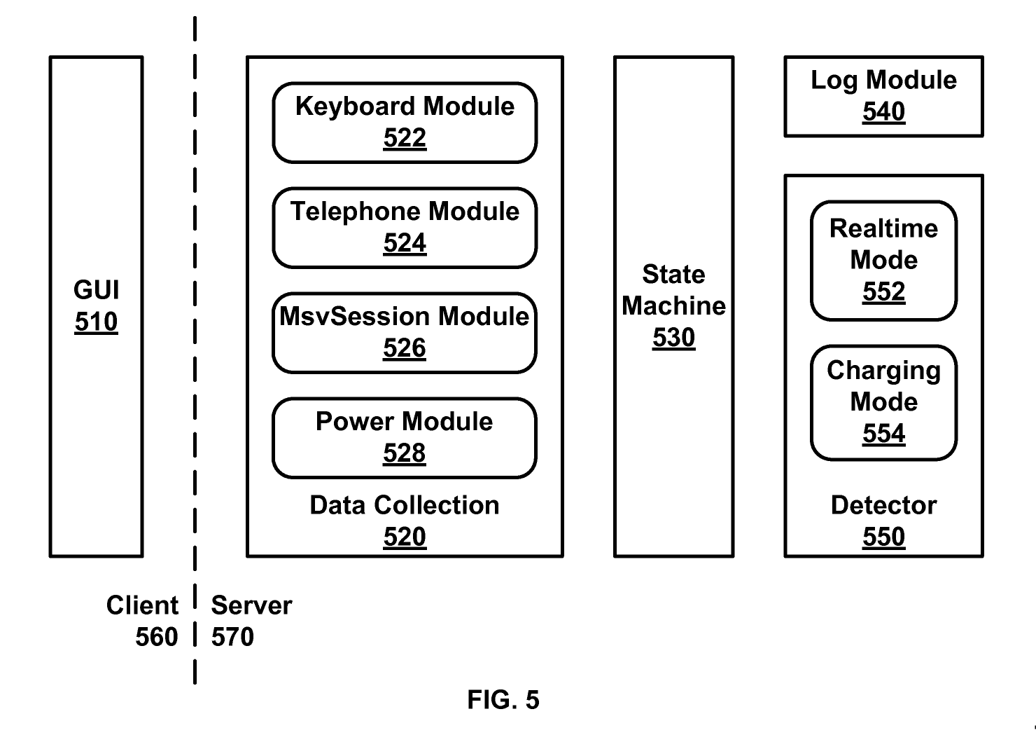

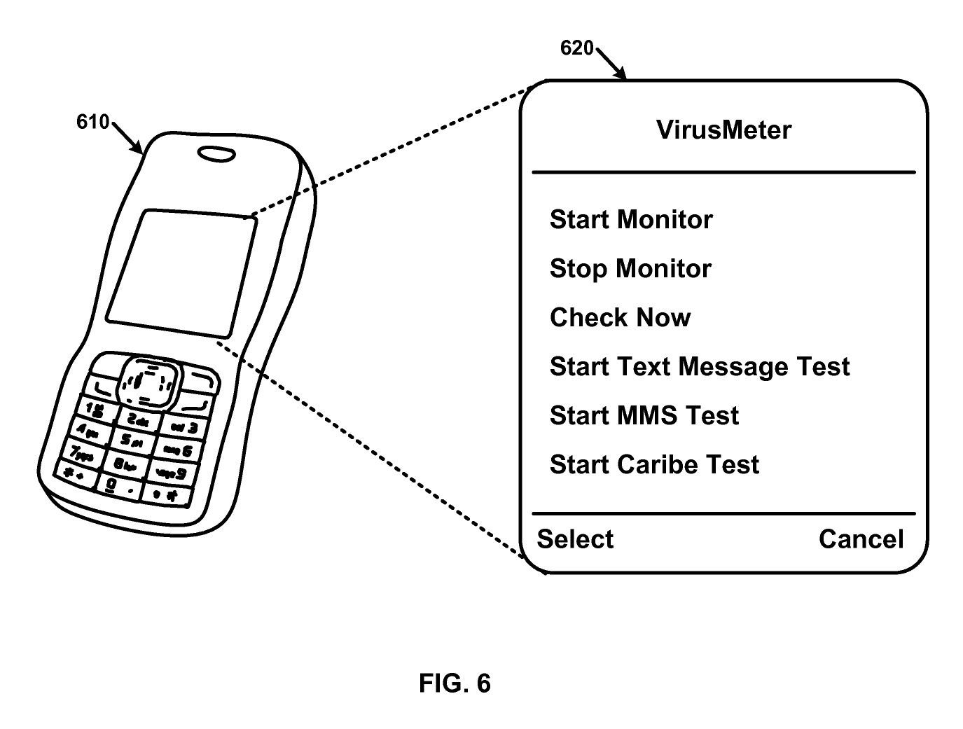

As Symbian is a popular mobile OS, an example prototype embodiment was constructed on a Nokia 5500 Sport, supported by Symbian OS 9.1. Example FIG. 5 illustrates modules 510 through 554 employed by embodiments of this example implementation. Currently, this example embodiment was implemented as a user level application that may be started and shut down manually by a user. The implementation program employs a client/server architecture that may be employed for Symbian applications. Example FIG. 6 illustrates a user interface 620 running on a mobile device 610 for an example embodiment. User interface 620 illustrates commands to perform functions such as start monitor, stop monitor, Check now, Start text Message Test, Start MMS Test and Start Caribe Test. One skilled in the art will recognize that many interfaces maybe used and that this illustration is only an example interface.

Power Measurement Precision and Power Model Construction

According to some embodiments, power consumption data may be collected through APIs provided by Symbian for power status changes. However, in some cases, the precision of the power capacity measurement may not be sufficient. The precision returned by the APIs of assorted mobile devices may vary significantly. For example, as iPhone may return the current power capacity at approximately 1% precision. Other devices may return the power consumption data only at the level of battery bars shown on the screen. On the Nokia 5500, these bars are at the 100, 85, 71, 57, 42, 28, 14, and 0 percent of the full capacity. The battery supply between two of these successive values may be referred to as a power segment. To overcome the precision challenge, experiments may be performed long so that power consumption is sufficient to cross a segment. Assuming a constant draining rate during the experiments, the power measurement through this method may be more accurate.

The power model in Equation 3 may be transformed so that experiment samples may not have the same constant dependent value ΔP, which may not be compatible with linear regression and/or neural network regression. The function may be transformed as follows. In experiments with the example embodiment, the signal strength was always good (at level 6 and 7) but the duration of idle time had a large range. Idle time at the best signal strength may be selected as the dependent variable, and the model transformed to:

D_{idle}=f′(D_{call}ⁱ, SS_{call}ⁱ, T_{msg}^{j}, S_{msg}^{j}, SS_{msg}^{j}, N_{msg}^{j}, . . . , D_{idle}^{k}, SS_{idle}^{k}) (4)

For environmental factors, some embodiments of the present invention may be concerned about the signal strength and network condition. Through the API, some embodiments of the present invention may directly query the current signal strength. There are 7 levels of signal strength on Nokia 5500, from 1 to 7. However, direct query of APIs for network conditions may not always be dependable when a user performs a certain operation, such as text messaging. If the network congestion is relatively severe, the duration for sending and/or receiving messages may increase significantly. Therefore, according to some embodiments, to make the power model more accurate, one may introduce the sending time and/or measure the duration as follows. In Symbian, sending a message may lead to a sequence of events that may be captured by some embodiments of the present invention. An index may be created in a draft directory; the index may be moved to a sending directory and/or when sending is successful, the index may be moved to a sent directory. Hence, the operation time may be measured from the time when the index is created to the time when it is moved to the sent directory. Following a similar workflow, a parameter input may be refined for receiving messages and/or other networking operations.

Although a power model may be configured in such a way due to insufficient power precision, a malware does not need to be active throughout a segment of battery power to be detected by some embodiments of the present invention. Instead, no matter how long the malware is active, runtime data may be fed and/or collected during an entire power segment for malware detection.

Data Collection Rules

According to some embodiments, power consumption data under normal user operations (e.g., clean data) for the three power models, as well as dirty data when malware is present, to train a decision tree may be collected to construct a power model. Due to constraints by the precision of a battery power measurement offered by Symbian OS, all user operations conducted in one battery segment may be treated as a batch to achieve more accurate detection. However, other embodiments using different OSes may not need to compensate for these constraint(s). To detect malware whose activities lead to abnormal power consumption no matter how long they are active, clean data may be collected under various circumstances for model construction: (1) In some experiments, data collection may focus on a single user operation. For example, in a battery segment, only SMS text messages may be sent, and in another one, only SMS text messages may be received; (2) In some experiments, mixed user operations may be conducted. For example, in a battery segment, phone calls may be made and text messages also received; (3) For each user operation, various properties of the activity may be considered. For instance, text messages with different sizes ranging from ten bytes to a thousand bytes may be sent; and (4) In all experiments, abnormal conditions may be avoided, which may decrease the accuracy of the power models.

According to some embodiments, dirty data may also be necessary to train decision trees. The power consumption of a malware program may vary significantly in different environments. For example, different usage frequencies and/or spy call durations on FlexiSPY may cause great difference in power consumption. In another example, the power consumed by the Cabir worm may depend on how many Bluetooth devices exist in the neighborhood. Based on such considerations, dirty data may be collected as follows: (1) During dirty data collection, conduct experiments to cover as many different scenarios as possible, including both high power consumption cases and low power consumption cases; and (2) For the purpose of model training, the fraction of high and low power consumption data samples may be randomly selected.

Stepwise Regression for Data Pre-processing and Time-Series Data Analysis

In testing of the example embodiments, collected data, including both clean and dirty data, have 41 variables that are measurable through the Symbian APIs. To simplify the model by eliminating insignificant factors, a stepwise regression technique was employed to pre-process the collected data. Stepwise regression is a statistical tool that helps find the most significant terms and remove least significant ones. Stepwise regression also provides information that may help to merge variables. Using stepwise regression, the idle time with signal strength level 6 was found to be insignificant in the experiment. This is because in the experimental environment, there was often good signal strength at level 7. The signal strength 6 is relatively rare. Thus, the signal strength 6 was merged to the signal strength 7.

To further improve model accuracy, data samples were collected from multiple segments. The average was employed to smooth out fluctuations due to internal electro-chemical battery properties. Three sets of input for each power model were generated in the test with the example embodiment. Experiments using models built from data samples collected in a single battery power segment were termed “short-term” experiments. Experiments using models built from data samples from seven segments were termed “middleterm” experiments. Note that Nokia 5500 only has seven battery segments. Data samples collected in more than one battery lifecycle may be employed. In experiments, four battery lifecycles were employed, which correspond to 28 segments. These experiments were termed “long-term” experiments. A stealthy malware that does not consume much power in one segment may not be caught in a short-term detection, but may be caught in the middle- and/or long-term detection.

Evaluation Results

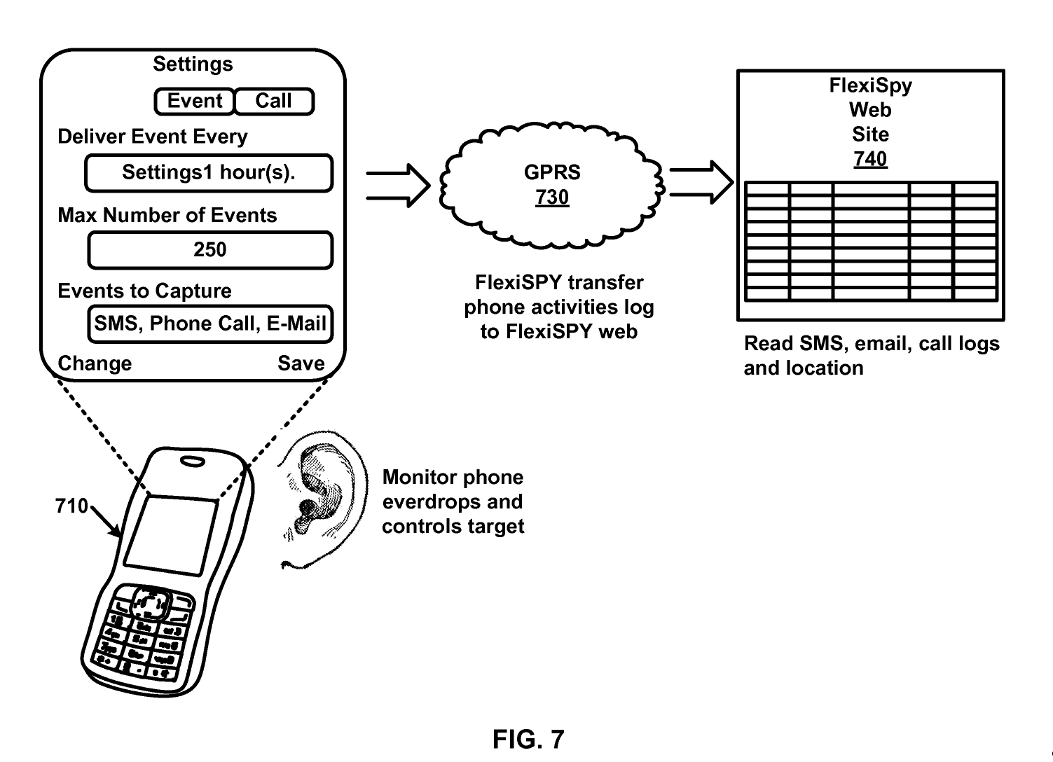

Actual mobile malware, including FlexiSPY, Cabir, and some variants of Cabir were used to evaluate the effectiveness of some embodiments of the present invention. FlexiSPY is a spyware program that runs on either Symbian OS and/or Blackberry handheld devices . Once installed, FlexiSPY conducts eavesdropping, call interception, GPS tracking, etc. FlexiSPY monitors phone calls and/or SMS text messages, and/or may be configured to send them to a remote server. Three major types of misbehaviors supported by FlexiSPY were tested: eavesdropping (e.g., spy call), call interception, and/or message (e.g., text message and/or email) forwarding. Example FIG. 7 illustrates an information flow of FlexiSPY. The Cabir malware exploits Bluetooth to spread themselves. Three Cabir variants were used in the experiments; two of them were employed for decision tree training and the other one was employed for testing.

Several sets of experiments examined common malware behaviors that consume relatively low (e.g., Cabir), medium (e.g., text-message forwarding) and high battery power (e.g., eavesdropping). False positives and/or runtime overhead, i.e., power consumption were also evaluated.

Experiments on Eavesdropping Detection

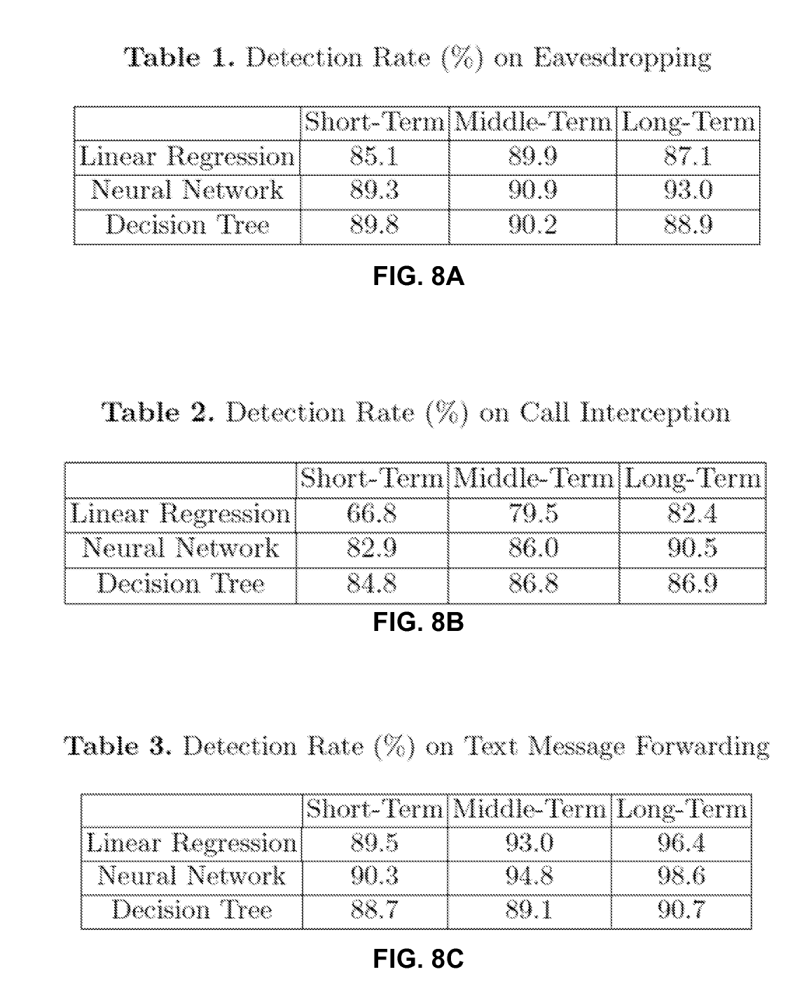

When using FlexiSPY to eavesdrop on a cellphone, the attacker makes a call 710 to a previously configured phone number and then the phone is activated silently without user authentication. Phone activities logs may be transferred to a FlexiSpy web site 740 using GPRS 730. Power measurements show that eavesdropping has a similar power consumption rate as a normal call. In experiments, spy calls of different time durations uniformly ranging from approximately 1 minute to 30 minutes were made. More than 50 samples were collected in this and each of the following detection rate experiments. Example FIG. 8A (Example Table 1) illustrates detection rates (e.g., true positives).

The results show that for eavesdropping, both middle-term and long-term experiments may improve the detection rates for linear regression and/or neural network, compared with short-term detection. However, even short-term linear regression achieves a detection rate over approximately 85%. This may result since eavesdropping consumes a lot of power, which makes short-term detection relatively accurate. Surprisingly, in these experiments, the long-term detection based on linear regression generates a worse result relative to mid-term detection. Due to the inaccurate linear relationship between variables, more errors may be accumulated in long-term experiments, which may lead to relatively worse results. This may apply to long term decision tree as well.

Experiments on Call Interception Detection

FlexiSPY may also perform call interceptions, which enables the attacker to monitor ongoing calls. A call interception differs from eavesdropping in that the call interception may only be conducted when a call is active. After FlexiSPY is installed, when the victim makes a call to a pre-set phone number, the attacker will automatically receive a notification via text message and silently call the victim to begin the interception.

In the detection experiments, call interceptions with different time durations uniformly ranging from approximately 1 minute to 30 minutes were performed. Example FIG. 8B (Example Table 2) illustrates the detection rate. The short-term linear regression detection results are not very good relative to neural network and/or decision tree. This may result since call interception only consumes slightly more battery power than a normal phone call and it only works when a call is active. However, middle-term and/or long-term experiments may significantly improve the detection rate for linear regression. The results confirm that for stealthy malware that consumes only a small amount of power, a more accurate model and/or a longer detection time may help relatively improve the detection accuracy.

Experiments on Text-Message Forwarding and Information Leaking Detection

FlexiSPY may also collect user events, such as call logs, and then deliver collected information via a GPRS connection periodically at a pre-configured time interval. Transferring data through GPRS consumes power and the power consumption may depends on the time interval and the characteristics of user operations, such as the number of text messages sent during each interval.

In the detection experiments, interval was set from approximately 30 minutes to 6 hours, with an interval of approximately 30 minutes. Under each setting, text messages of different sizes ranging from approximately 10 bytes to 1000 bytes were sent and received. Example FIG. 8C (Example Table 3) illustrates the detection results. All three approaches achieve detection rates above approximately 88%. The long-term detection with linear regression and/or neural network may achieve a detection rate up to approximately 98.6%. Analysis shows that this may result since a FlexiSPY functionality consumes additional power other than communication. When an interval is large, FlexiSPY may not transfer data for a while, although FlexiSPY still needs to monitor and/or save information related to user activities, which also consumes battery power. Thus, even in short-term experiments, the detection rate is quite high. In this example experiment, the decision tree did not achieve comparable results to linear regression and/or neural networks for middle term and long-term detection. The performance of decision tree might be highly related to the training dataset, for which may be constrained by a limited number of malware samples.

Experiments on Detecting Cabir

Cabir, a cellphone worm spreading via Bluetooth, searches nearby Bluetooth equipment and then transfers a sis file to them once found. The power consumption of Cabir mainly comes from two parts: neighbor discovery and/or file transferring. Because Bluetooth normally does not consume significant battery power, experiments were conducted in an environment full of Bluetooth equipment, in which Cabir keeps finding new equipment and thus consumes a non-trivial amount of power. To control the frequency of file transferring, Bluetooth on these devices was repeatedly turned off for a random amount of time after a transfer completed and then turned on again.

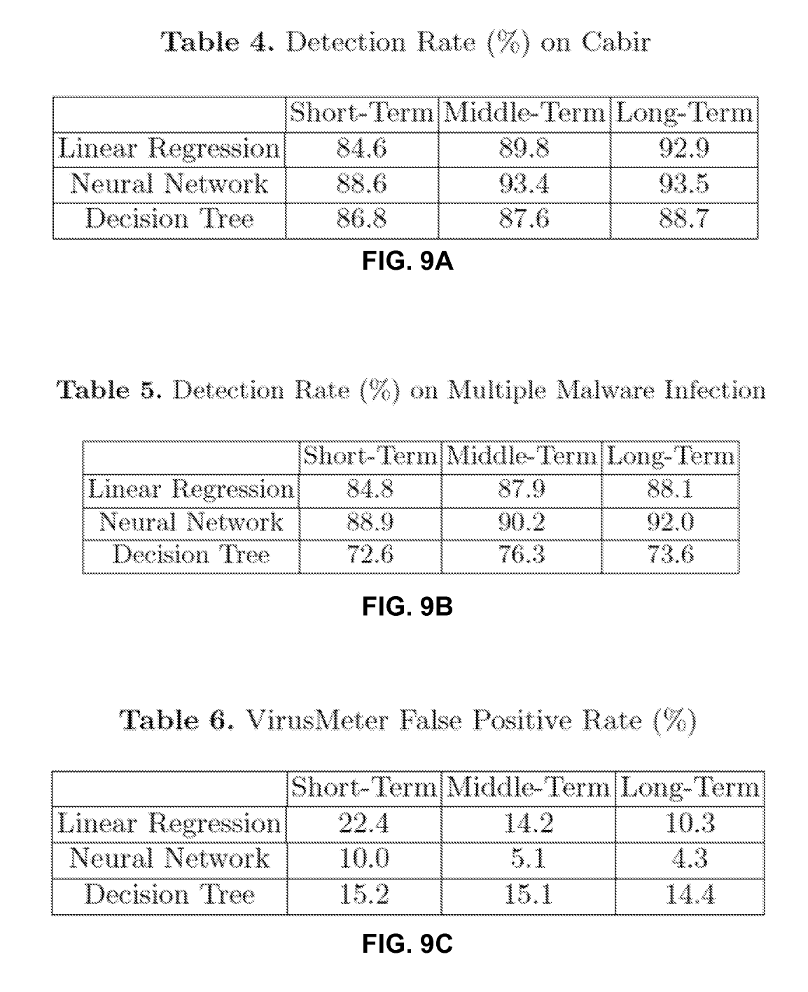

Example FIG. 9A (Example Table 4) illustrates the detection results. For linear regression, the middle-term and/to long-term detection may remarkably improve the detection result. The table also indicates that although Bluetooth discovery and/or file transferring only consume a limited amount of battery power, it may be detected with a reasonably and/or relatively high rate by some embodiments of the present invention at real time.

Experiments on Detecting Multiple Malware Infections

Previous detection experiments all involved only one malware program running on a cellphone. It is possible that a mobile device is infected by more than one malware program and each malware program could perform different attacks simultaneously. To test such cases, an experiment was run that activated both FlexiSPY and Cabir on an example embodiment and randomly conduct various attack combinations.

Example FIG. 9B (Example Table 5) illustrates the detection rates. The results show that linear regression and/or neural network have reasonably relatively high true positive rates. Decision tree results had a much relatively higher false negative rate than in single malware infection experiments. Although it is seemingly counterintuitive, the underlying principle of these three approaches may explain this result. Linear regression and/or neural network regression may only predict the power consumption of normal user operations, rather than describing power consumption of specific malware activities, which is the objective of decision tree. However, the decision tree model was not trained with a mixture of malware samples. Thus, for data samples collected when multiple malware programs are active, its performance was the worst in this particular experiment. In embodiments, such information may be determined and/or applied to address various types of attacks on various devices and/or operating systems.

False Positive Experiments

In addition to the detection rates, experiments were also conducted to evaluate false positives. By feeding power models with a clean dataset, the prediction result may be obtained and the false positive rate calculated. For this purpose, more than 100 clean data samples were collected for experiments.

Example FIG. 9C (Example Table 6) illustrates the false positive rates. The results show that linear regression in short-term detection has the relative highest false positive rate. This may result from the inaccuracy of the underlying assumption of linear regression model. However, both middle-term and/or long-term experiments may significantly reduce the false positive rates. With a more accurate power model, neural network achieves the best results among the three for all three terms.

Overhead Measurements

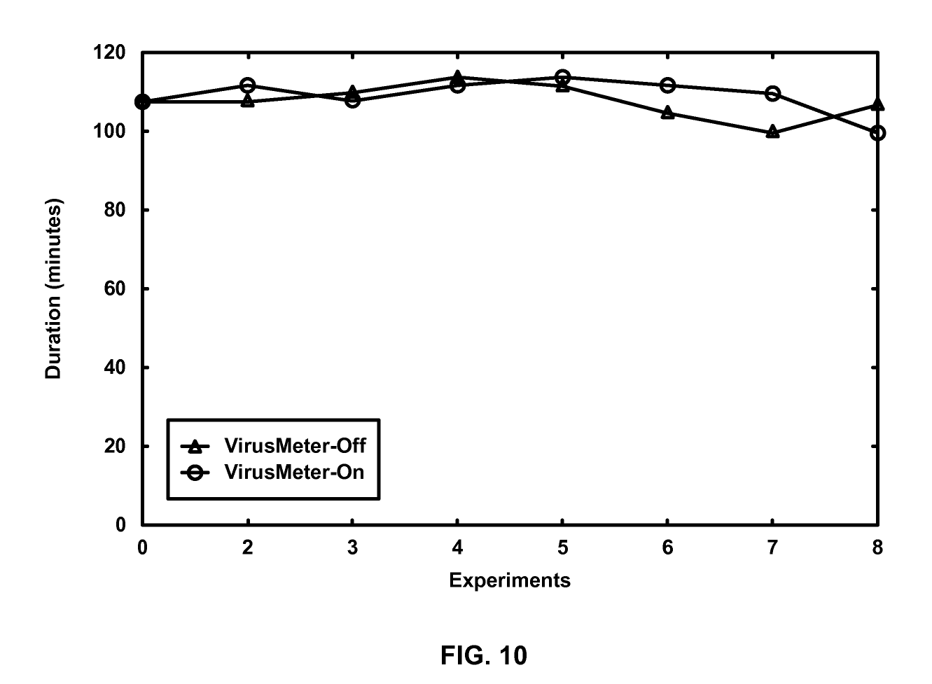

As some embodiments of the present invention may be configured to run on commodity devices, power consumption overhead may be of concern. Some embodiments of the present invention may not be capable of directly measuring power consumption. Therefore, experiments were conducted as follows: with and without some embodiments of the present invention running on a cellphone, same sets of user operations are performed. The operating durations may be compared under these two scenarios. Example FIG. 10 illustrates experimental results. With and without some embodiments of the present invention, the duration of various user operations is very close. The average duration when some embodiments of the present invention is off is approximately 109.5 minutes across the experiments, while the average duration when some embodiments of the present invention are on is approximately 108 minutes. This indicates that some embodiments of the present invention running overhead is less than approximately 1.5%. Note the above results show the overhead when some embodiments of the present invention employ the linear regression model. For the other two approaches, the power consumption was not evaluated because the other two approaches may run in a battery-charging mode.

Further Discussion

Some embodiments of the present invention have the potential to detect any misbehavior with abnormal power consumption as long as the battery power metering is sufficiently and/or relatively accurate. Currently, the precision of battery power indicators vary significantly among different mobile OSes, which may affect the detection efficiency of some embodiments of the present invention. This is particularly important for real-time detection. Practically, on the experimental embodiment, this changes the real-time detection mode of some embodiments of the present invention to a near-real-time mode.

Since some embodiments of the present invention rely on the user-centric power models to detect malware, the accuracy of the models themselves is important. Experimental results have shown that linear regression, although consuming trivial additional power, may generate high false negative rates due to the inaccurate underlying assumption between variables. On the other hand, in a battery-charging mode, neural network often improves the detection rate remarkably due to lack of such an assumption. The decision tree model may not perform as effectively as neural networks in experiments. Limited malware samples may adversely affect performance. In addition, for some types of user operations, such as entertainment and Web surfing, more fine-grained profiling may further improve the accuracy of the power model.

Some embodiments of the present invention may also run in the battery-charging mode to improve the detection accuracy. Malware may leverage this as well, since when the battery is charging, there is no way for some embodiments of the present invention to accurately measure the power consumption without any external assistance. To capture this kind of malware, some embodiments of the present invention may employ external devices to measure how much power is charged and how much power is consumed. On the other hand, currently most mobile OSes are only accessible to manufacturers. Some embodiments of the present invention may become more resilient to attacks that could fail signature- and/or anomaly-based detection schemes.

As presented above in some aspects of embodiments, processes and/or devices may determine a probable attack. According to embodiments, an attack may include any element configured to provide potential and/or actual damage to a computing device. In one aspect of embodiments, an attack may include malware. In embodiments, an attack may include employing a hardware interface. In one aspect of embodiments, an attack may employ Bluetooth hardware to potentially and/or actually damage a mobile computing device. In embodiments, an attack may include eavesdropping. In embodiments, an attack may include conversation interception. In embodiments, an attack may include data interception. In embodiments, an attack may include text message forwarding. In embodiments, an attack may include information leaking. In embodiments, an attack may include denial of service. In one aspect of embodiments, an attack may include a plurality of attacks in sequence and/or in parallel.

According to embodiments, a computing device may include any device having one or more processors and/or communication interfaces. In embodiments, a communication interface may include one or more wired and/or wireless communication interfaces. In embodiments, a device may be configured to communicate employing WiFi, Bluetooth, cellular, firewire, USB, ethernet, and/or the like. In one aspect of embodiments, a communication interface may include an antenna for wireless communication. In another aspect of embodiments, a communication interface may include a port and/or a touch screen for wired communication. In embodiments, a computing device may include a cell phone, a PDA, a tablet, an MP3 player, a netbook, a laptop, a computer, and/or a networked device, and/or the like.

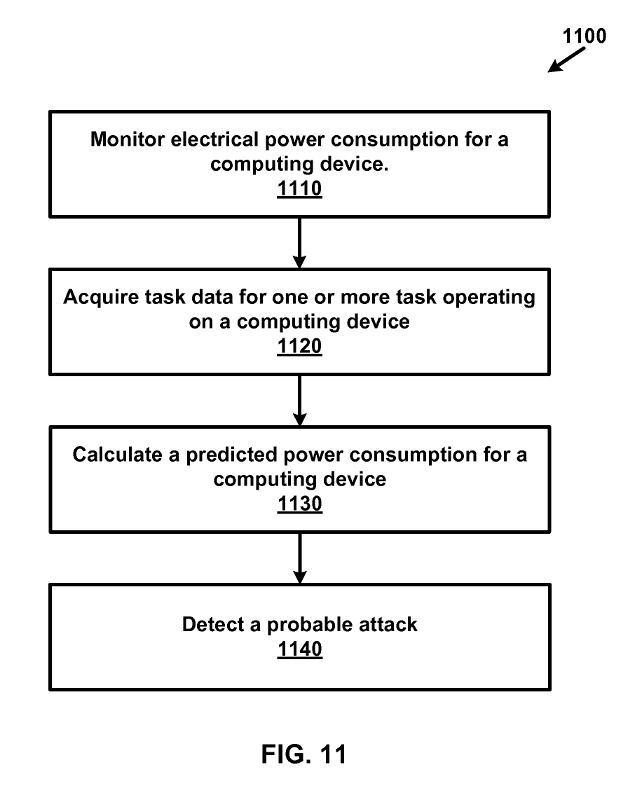

Referring to example FIG. 11, a process to determine a probable attack is illustrated in accordance with one aspect of embodiments. In embodiments, a process to determine an attack 1100 may include monitoring electrical power consumption for a computing device 1110, acquiring task data for one or more task operating on said computing device 1120, calculating a predicted electrical power consumption for said computing device 1130 and/or detecting a probable attack 1140.

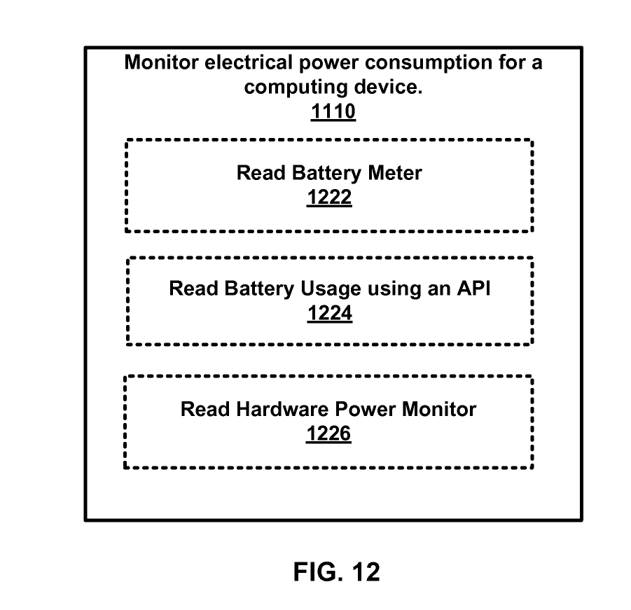

According to embodiments, a process to determine an attack may include monitoring one or more metrics for a device. Referring to example FIG. 12, a metric may include power consumption, for example electrical power consumption for a computing device. In embodiments, monitoring electrical power consumption for a computing device 1110 may include employing a battery meter to monitor electrical power consumption 1222 of a device. In one aspect of embodiments, a battery meter may be visible to a device user.

According to embodiments, monitoring electrical power consumption for a computing device may include employing a battery usage API to monitor electrical power consumption 1224 of a device. In one aspect of embodiments, an operating system may interface with device hardware to provide a value of a metric. In another aspect of embodiments, an operating system may be configured to directly provide a value for a metric.

According to embodiments, monitoring electrical power consumption for a computing device may include employing a hardware power monitor to monitor electrical power consumption 1226 of a device. In one aspect of embodiments, a hardware power monitor may include an analog-to-digital converter, which may be configured to provide an electrical power value, for example a current and/or voltage value. In another aspect of embodiments, a digital portion of an analog-to-digital converter may be disposed at an input/output location and/or memory port. In embodiments, a value for a power metric may be related to battery status, battery health, charge level and/or charge completion time for a battery in a computing device, including history data.

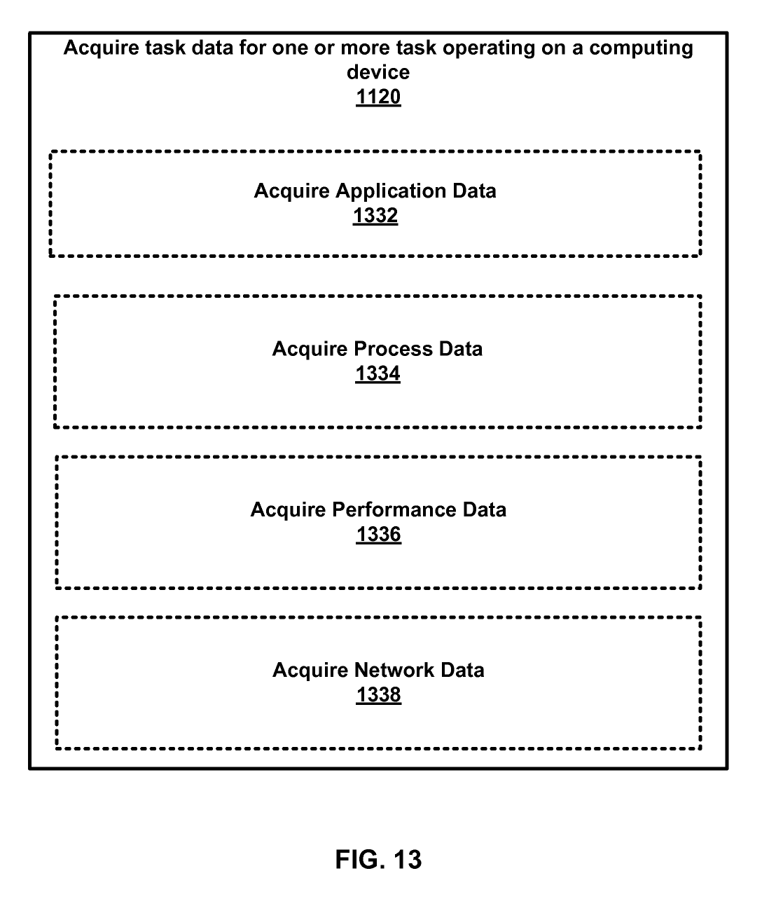

Referring to example FIG. 13, a process to determine a probable attack may include acquiring data for one or more tasks operating on a computing device 1120. According to embodiments, one or more tasks may be configured to enable one or more activities on a device, for example talking, texting, browsing, reading, listening, viewing, displaying, and/or computing. In embodiments, acquiring task data may include acquiring application data 1332. In one aspect of embodiments, application data may be information related a task, for example status of an application. In embodiments, acquiring task data may include acquiring processes data 1334. In one aspect of embodiments, processes data may include information related to processes, for example image name, user name CPU and/or memory usage. In embodiments, acquiring task data may include acquiring performance data 1336. In embodiments, performance data may include information related to device performance, for example CPU usage data, page file usage data, memory data, commit charge data and/or total data. In one aspect of embodiments, total data may include handles, threads and/or processes data. In another aspect of embodiments, memory data may include physical memory and/or kernel memory. In embodiments, acquiring task data may include acquiring networking data 1338 for one or more tasks operating on a device. In embodiments, networking data may be information related to connecting a device to a network, for example adapter name, network utilization, link speed and/or adapter state. In embodiments, data acquired may include history data, for example history performance data.

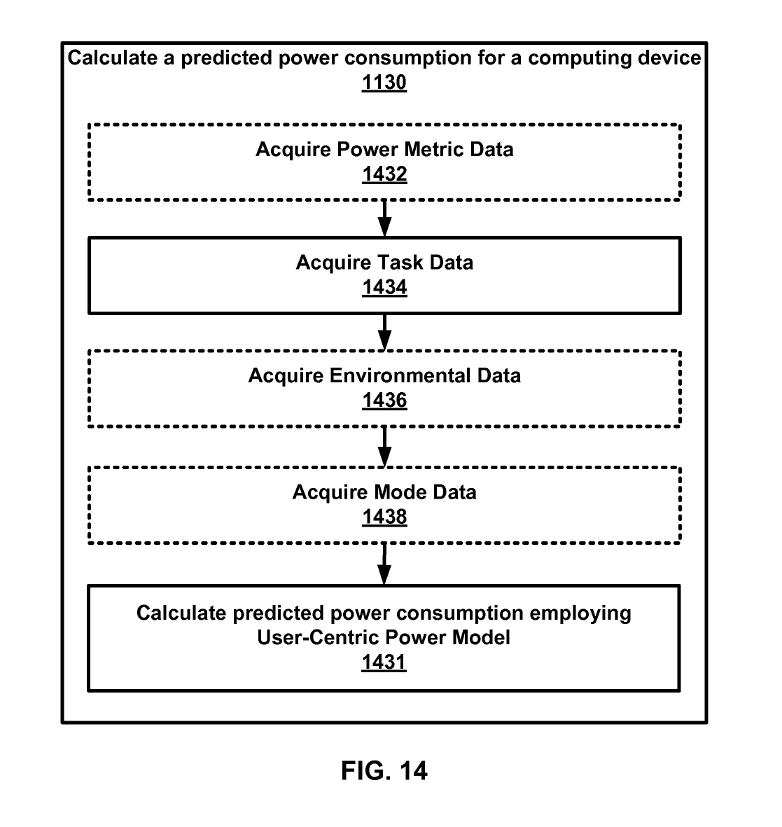

Referring to example FIG. 14, a process to determine a probable attack may include calculating one or more predicted metrics for a device, for example, calculating predicted electrical power consumption 1130 for a computing device. In embodiments, calculating one or more predicted metrics for a device may include employing one or more models 1431, power metric data 1432, task data 1434, environmental data 1436 and/or mode data 1438. In one aspect of embodiments, metric data 1432 may include electrical power consumption data, history of electrical power consumption, and/or like. In another aspect of embodiments, task data 1434 may include process data, history of process data and/or the like. In a third aspect of embodiments, environmental data 1436 my include signal strength data, history signal strength data and/or the like

According to embodiments, calculating a predicted electrical power consumption may include mode data 1438 In one aspect of embodiments, mode data 1438 may include data related to a real-time mode. In another aspect of embodiments, mode data 1438 may include data related to a power saving mode. In a third aspect of embodiments, mode data 1438 may include data related to a charging mode. In a fourth aspect of embodiments, mode data 1438 may include data related to a learning mode. In a fifth aspect of embodiments, mode data 1438 may include data related to a monitoring mode. In embodiments, modes may partially and/or completely overlap, for example a real-time mode overlap with a charging mode, a monitoring mode overlap with a learning mode, and/or the like., such that mode data may partially and/or completely overlap. In one aspect of embodiments, mode data may include data identifying a mode a device is, has and/or will employ. In another aspect of embodiments, mode data may include any other data related to a mode, for example test information related to a learning mode.

According to embodiments, one or more modes may conduct one or more tests. In embodiments, a learning mode may conduct a task test for one or more tasks. In one aspect of embodiments, a task test for one or more tasks may include performing a task to test a device for a metric value, for example creating a task to test a mobile computing device for an electrical power consumption. In embodiments, a learning mode may conduct an attack test. In one aspect of embodiments, an attack test may include selecting and/or performing an attack to test a mobile computing device for an electrical power consumption. In embodiments, a learning mode may conduct a baseline test. In one aspect of embodiments, a baseline test may include running a test during a mobile computing device baseline for an electrical power consumption. In embodiments, a baseline test may be correlated to one or more modes, for example a baseline for a real-time mode, and/or the like. In embodiments, a learning mode may conduct an operations test. In embodiments, an operations test may include creating a user operation to test a mobile computing device for an electrical power consumption.

According to embodiments, one or more modes may conduct one or more tests for one or more conditions. In embodiments, a condition may include a temporal condition. In one aspect of embodiments, a temporal condition may include time of day. In embodiments, a condition may include a network condition. In one aspect of embodiments, a network condition may include network capacity, network congestion, network signal strength and/or network quality of service. In embodiments, a condition may include a message condition. In one aspect of embodiments, a message condition may include message length, which may not be linear. In embodiments, a condition may include an operation condition. In one aspect of embodiments, an operation condition may include receiving communications and/or ending communications. In embodiments, a condition may include a task condition. In one aspect of embodiments, a task condition may include time of task execution and/or intensity of task. In embodiments, one or more conditions may be employed irrespective of test data, for example as a portion of environmental data 1436.

According to embodiments, one or more modes may include an adaptive mode. In embodiments, one or more feedbacks may be provided between two or more modes to provide an adaptive mode. In one aspect of embodiments, a feedback may be employed to provide an adaptive learning mode. In embodiments, a feedback loop may be formed between a monitoring mode and a learning mode to provide an adaptive learning mode.

According to embodiments, calculating a predicted electrical power consumption may include one or more models 1431. In embodiments, model 1431 may include a user-centric power model. In one aspect of embodiments, user-centric power model 1431 may include a hardware component model. In another aspect of embodiments, user-centric power model 1431 may include a battery model. In a third aspect of embodiments, user-centric power model 1431 may include a linear battery model. In a fourth aspect of embodiments, user-centric power model 1431 may include a discharge rate dependent model. In a fifth aspect of embodiments, user-centric power model 1431 may include a relaxation battery model.

According to embodiments, a user-centric power model may include one or more inputs. In one aspect of embodiments, an input may include one or more user operations. In another aspect of embodiments, an input may include one or more environmental factors. In a third aspect of embodiments, an input may include one or more system calls.

According to embodiments, a user-centric power model may solve one or more functions, for example solve a power function. In embodiments, a user-centric power model may solve a power function by employing one or more machines. In one aspect of embodiments, a machine may include a state machine. In another aspect of embodiments, a power function may include a linear regression function., a neural network function and/or decision tree function. In embodiments, machines and/or functions may be tailored and/or employed to address various types of attacks on various devices and/or operating systems.

According to embodiments, a model may vary depending on a mode. In one aspect of embodiments, a user-centric power model may vary depending on a mode. In embodiments, a user-centric power model may vary depending on a learning mode, for example when a learning mode is conducting one or more tests. In embodiments, for example, a user-centric power model may vary to account for operations which may not be tested. In embodiments, a user-centric power model may vary by discounting values related to one or more tests, by modifying one or more power functions, by selecting one or more power functions, and/or the like.

According to embodiments, calculating a predicted electrical power consumption may be performed on an external computing device. In one aspect of embodiments, an external computing device may include a server, a personal computer and/or another mobile computing device, and the like. In another aspect of embodiments, an external computing device may be a user's computing device, a providers computing device and/or another third-party computing device. In embodiments, any communication processes and/or interfaces may be employed to share data. In embodiments, sharing data may include further security features such as encryption and/or authentication processes, for example IPSec, PKA, SQL, and the like.

According to embodiments, a process may include detecting a probable attack on a computing device. In embodiments, detecting a probable attack may include employing one or more models, metrics, task data, environmental data and/or mode data. In one aspect of embodiments, a probable attack may be detected when electrical power consumption disagrees with predicted electrical power consumption. In another aspect of embodiments, electrical power consumption may disagree with a predicted electrical power consumption by a determined margin to provide a probable attack detection.

According to embodiments, a process to detect a probable attack may include calculating a probability of attack. In one aspect of embodiments, calculating a probability of attack may include performing a statistical analysis, which may be based on a magnitude of disagreement between electrical power consumption and predicted electrical power consumption.

According to embodiments, a process to detect a probable attack may include responding to detecting a probable attack. In embodiments, responding may include restoring a computing device to a pre-attack state. In one aspect of embodiments, restoring to a pre-attack state may include retrieving and/or loading an image from memory. In embodiments, memory may be local on a computing device and/or on an external computing device. In embodiments, responding may include monitoring an attack. In one aspect of embodiments, monitoring an attack may include passive monitoring, for example running a Sniffer program, monitoring data usage, power usage and/or the like. In another aspect of embodiments, monitoring an attack may include active monitoring, for example, inserting data for tracking purposes, running one or more tests, and the like.

According to embodiments, responding may include running anti-attack software. In one aspect of embodiments, anti-attack software may include Symantec antivirus, NetQin and/or the like. In embodiments, responding may include alerting a user of a computing device. In one aspect of embodiments, alerting the use may include a text, email, phone, SMS and or any other visual and/or auditory message. In embodiments, responding may include powering off a computing device. In embodiments, detecting a probable attack may be performed on an external computing device.

Embodiments relate to a non-transient tangible computer readable medium. In embodiments, a non-transient tangible computer readable medium may include a series of computer readable instructions, that when executed by one or more processors, may perform a method. In one aspect of embodiments, a non-transient tangible computer readable medium may include any non-transient medium capable of storing data in a form that may be accessed and/or read by an automated sensing device. In embodiments, for example, a non-transient tangible computer medium may include magnetic disks, cards, tapes, and drums, punched cards and paper tapes, optical disks, magnetic ink characters, barcodes and/or the like.

According to embodiments, a method performed by one or more processors may include monitoring one or more metrics for a device, for example monitoring electrical power consumption for a computing device. In embodiments, a method performed by one or more processors may include acquiring one or more power metrics for a device, for example acquiring history power consumption data. In embodiments, a method performed by one or more processors may include acquiring data for one or more tasks operating on a device, for example acquiring task data for one or more tasks operating on a computing device. In embodiments, a method performed by one or more processors may include acquiring one or more environmental data for a device, for example acquiring signal strength data.

According to embodiments, a method performed by one or more processors may include calculating one or more predicted metrics for a device, for example calculating predicted electrical power consumption for a computing device. In one aspect of embodiments, calculating a predicted electrical power consumption for a computing device may include employing a user-centric power model and/or acquired task data. In embodiments, a method performed by one or more processors may include detecting a probable attack. In one aspect of embodiments, a probable attack may be detected when electrical power consumption disagrees with predicted electrical power consumption by a determined margin.

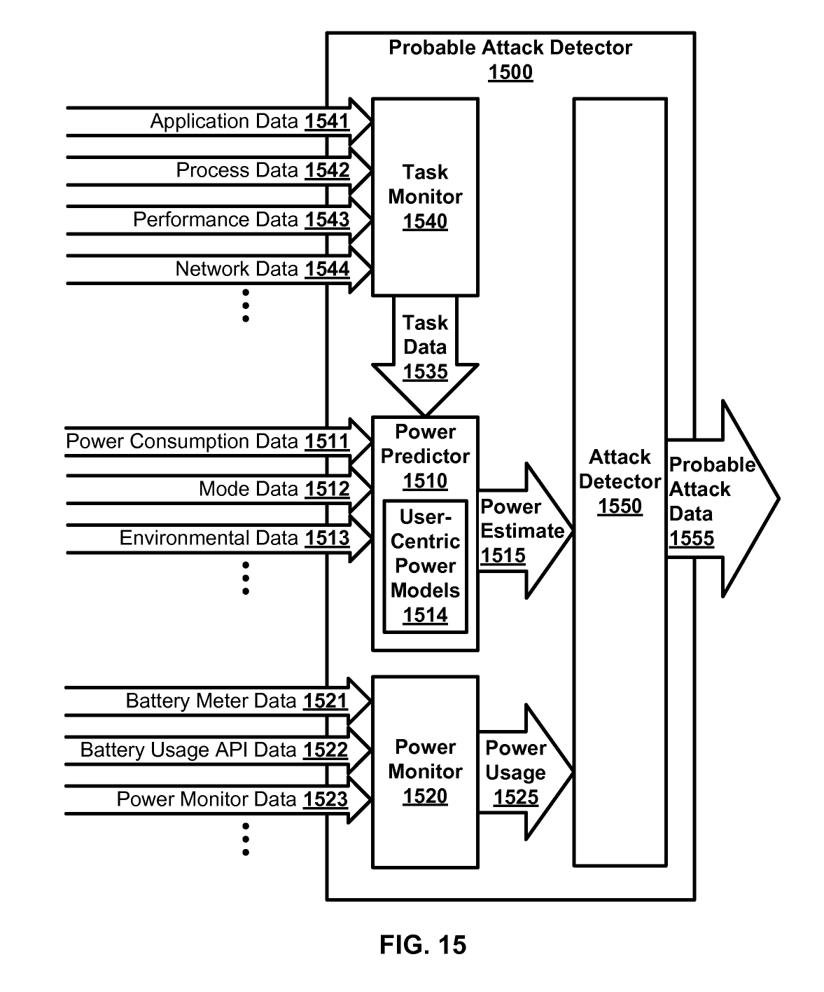

Embodiments relate to a computing device. Referring to example FIG. 15, probable attack detector 1500 is illustrated in accordance with one aspect of embodiments. According to embodiments, probable attack detector 1500 may include one or more metric predictors. In embodiments, a metric predictor may include a power predictor 1510, for example configured to calculate a predicted electrical power consumption for a computing device. In one aspect of embodiments, power predictor 1510 may be configured to employ user-centric power model 1514. In another aspect of embodiments, power predictor 1510 may be configured to receive and/or process data, for example power consumption data 1511, model data 1512, environmental data 1513 and/or task data 1535. In embodiments, power predictor 1510 may be configured to transmit data, for example power estimate 1515.

According to embodiments, probable attack detector 1500 may include one or more metric monitors. In one aspect of embodiments, a metric monitor may include power monitor 1520, for example configured to monitor electrical power consumption for a computing device. In embodiments, power monitor 1520 may receive and/or process data, for example battery meter data 1521, battery usage API data 1522 and/or power monitor data 1523. In embodiments, power monitor 1520 may transmit data, for example task data 1535.

According to embodiments, probable attack detector 1500 may include one or more task monitors. In embodiments, task monitor 1540 may be configured to receive and/or process data, for example application data 1541, process data 1542, performance data 1543 and/or network data 1544. In embodiments, power monitor 1520 may be configured to communicate data, for example power usage 1525.

According to embodiments, probable attack detector 1500 may include one or more attack detectors. In embodiments, attack detector 1550 may be configured to receive and/or process data, for example, power estimate 1515 and/or power usage 1525. In embodiments, attack detector 1550 may be configured to transmit data, for example, probable attack data 1555. In embodiments, probable attack data 1555 may represent a probable attack, for example when electrical power consumption disagrees with predicted electrical power consumption by a determined margin. In embodiments, attack data 1555 may be further processed, for example, to determine a probability of attack, may be stored and/or may be displayed for notification and/or responding processes.

The battery power supply is often regarded as the Achilles' heel of mobile devices. Provided that any activity conducted on a mobile device, either normal or malicious, inevitably consumes some battery power. Some embodiments of the present invention exploit this to detect existence of malware with abnormal power consumption. Some embodiments of the present invention relies on a concise lightweight user-centric power model and aims to detect mobile malware in at least two modes: While a real-time detection mode provides immediate detection, running some embodiments of the present invention under the battery-charging mode may further improve the detection accuracy without concerns of resource consumption. Using real-world malware such as Cabir and FlexiSpy, experiments show that some embodiments of the present invention may effectively and efficiently detect their existence.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) of attack detection on cell phones. However, one skilled in the art will recognize that embodiments of the invention could be used to detect unexpected behavior on any device that uses power. For example, embodiments of the present invention could be used to detect unexpected behavior on a networked DVD player or game consol. Furthermore, unexpected behavior may be indicative of unwanted or harmful execution.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A method comprising:
a. monitoring electrical power consumption of a computing device;
b. acquiring task data for at least one task operating on said computing device;
c. calculating a predicted electrical power consumption for said computing device employing:
i. a user-centric power model; and
ii. said task data; and
d. detecting a probable attack when said electrical power consumption disagrees with said predicted electrical power consumption by a determined margin.

2. A method according to claim 1, wherein said detecting said probable attack further includes calculating a probability of attack.

3. A method according to claim 1, further including responding to said detection said probable attack.

4. A method according to claim 3, wherein said responding includes at least one of the following:
a. restoring said computing device to a pre-attack state;
b. monitoring said attack;
c. running anti-attack software; [e.g. Symantec antivirus, NetQin]
d. alerting a user of said computing device;
e. powering off said computing device; or
f. a combination of the above.

5. A method according to claim 1, wherein said computing device is at least one of the following:
a. a cell phone,
b. a PDA;
c. a tablet;
d. an MP3 player;
e. a netbook;
f. a laptop;
g. a computer;
h. a networked device; or
i. a combination of the above.

6. A method according to claim 1, wherein said monitoring electrical power consumption employs at least one of the following:
a. a battery meter;
b. a battery usage API;
c. a hardware power monitor; or
d. a combination of the above.

7. A method according to claim 1, wherein said calculating said predicted electrical power consumption includes at least one of the following modes:
a. a real-time mode;
b. a power saving mode;
c. a charging mode;
d. a learning mode; or
e. a combination of the above.

8. A method according to claim 7, wherein said user-centric power model varies depending on said mode.

9. A method according to claim 1, wherein at least one of said at least one task is configured to enable at least one of the following activities:
a. talking;
b. texting;
c. browsing;
d. reading;
e. listening;
f. viewing;
g. displaying
h. computing; or
i. a combination of the above.

10. A method according to claim 1, wherein said learning mode conducts at least one of the following tests:
a. a task test for at least one of said tasks;
b. an attack test;
c. a baseline test; [may be correlated to a mode, i.e. real time mode]
d. an operations test; or
e. a combination of the above.

11. A method according to claim 1, wherein said learning mode is an adaptive learning mode.

12. A method according to claim 1, wherein said learning mode conducts a test for at least one of the following conditions:
a. time of day;
b. network condition;
c. network capacity;
d. network congestion;
e. network signal strength;
f. network quality of service;
g. message length; [may not be linear];
h. receiving communications;
i. sending communications;
j. time of task execution;
k. intensity of task; or
l. a combination of the above.

13. A method according to claim 1, wherein said attack includes at least one of the following:
a. malware;
b. a hardware interface; [e.g. Bluetooth]
c. eavesdropping;
d. conversation interception;
e. data interception;
f. text message forwarding;
g. information leaking;
h. denial of service; or
i. a combination of the above.

14. A method according to claim 1, wherein said user-centric power model includes at least one of the following:
a. a hardware component model;
b. a battery model;
c. a linear battery model;
d. a discharge rate dependent model;
e. a relaxation battery model; or
f. a combination of the above.

15. A method according to claim 1, wherein said user-centric power model inputs include at least one of the following:
a. user operations;
b. environmental factors;
c. system calls; or
d. a combination of the above.

16. A method according to claim 1, wherein said user-centric power model solves a power function employing at least one of the following:
a. a state machine;
b. a linear regression function;
c. a neural network function;
d. a decision tree function; or
e. a combination of the above.

17. A method according to claim 16, wherein said calculating said predicted electrical power consumption is performed on an external computing device.

18. A method according to claim 16, wherein said detecting said probable attack is performed on an external computing device.

19. A non-transient tangible computer readable medium comprising a series of computer readable instructions that when executed by one or more processors preforms a method comprising:
a. monitoring electrical power consumption for a computing device;
b. acquiring task data for at least one task operating on said computing device;
c. calculating a predicted electrical power consumption for said computing device employing:
i. a user-centric power model; and
ii. said task data; and
d. detecting a probable attack when said electrical power consumption disagrees with said predicted electrical power consumption by a determined margin.

20. A method according to claim 19, wherein said detecting said probable attack further includes calculating a probability of attack.

21. A computing device comprising:
a. an power monitor configured to monitor electrical power consumption for said computing device;
b. a task monitor configured to acquiring task data for at least one task operating on said computing device;
c. a power predictor configured to calculate a predicted electrical power consumption for said computing device employing:
i. a user-centric power model; and
ii. at least one of said at least one task; and
d. an attack detector configured to detect a probable attack when said electrical power consumption disagrees with said predicted electrical power consumption by a determined margin.
